(19) United States
(12) Patent Application Publication
(10) Pub. No.: US 2004/0174972 A1
(43) Pub. Date: Sep. 9, 2004

(54) Telephone conference system

(76) Inventors: Kitoshi Amano, Tokyo (JP); Takayuki Morimura, Tokyo (JP)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/379,883

(22) Filed: Mar. 4, 2003

(51) Int. Cl. H04M 3/42

(52) U.S. Cl. 379/202.01

(57) ABSTRACT

A phone conference system for making a conference using a plurality of phones which comprises a voice response board 6 for receiving push tone signals and voice signals transmitted from each phone, for transmitting push tone signals and voice signals, and for recording and reproducing voices in response to push tone signals, a voice synthesis board 8 having a plurality of conference rooms 16 in which voice signals from each phone received at said voice response board 6 are synthesized, and a control section 18 for controlling status of voice synthesis board 8 and for receiving line information from each phone and transmitting orders concerning connection by exchange of lines to voice response board 6 in response to status thereof. The control section 18 designates a conference room 16 to be connected to each line in regard to a plurality of lines received at voice response board 6. The voice signals of plurality of lines are synthesized and are connected by exchange in designated room. A plurality of persons are capable of making a conversation simultaneously through each phone.

### BACKGROUND OF THE INVENTION

This invention relates to a telephone conference system in which a conference is held by phone such as cell phone, PHS (Personal Handyphone System), fixed phone or the like.

Conventionally a telephone conference system is held using television phone. This requires a microphone, a video camera for transmitting an image, and a display for displaying the received image in addition to a usual phone equipment.

As a pure phone conference system in which image data is not exchanged there is an INS (Information Network System) phone conference service provided by NTT EAST (Nippon Telegraph and Telephone Corporation EAST). The service is one in which when a summoner previously registers date and hour of conference and participants of conference, the summoner and the participants are called for from the conference center on the designated day and hour. The system has advantages in that the conference can be held on time and at most 30 phones can be simultaneously connected. However, the simultaneous connecting service is offered through an operator and is limited in the daytime. Furthermore, the summoner assumes that the called participants are true participants and has to proceed a conference. As a result he cannot notice that the person not to be participated listens to the contents of the conference.

Furthermore, although at present PBX (private branch exchange) is mainly digital, the PBX uses IC (integrated circuits) without a memory function for connection by exchange. Even if the treatment is surely made, the PBX only has functions of connecting extension telephones and connecting the extension to the outside phone. Therefore, connection and disconnection cannot be made or not in accordance with the phone number of the sender.

In the meantime, recently a CTI (computer telephonic) system becomes widely used, and it is attempted to utilize function of connection of phone by a personal computer. This aims to combine voice network of phone network and data network of LAN (local area network) Specifically a personal computer is equipped with telephonic board for use in a personal computer as a phone and a private branch exchange. The PBX (private branch exchange) of the computer is called UnPBX and plays a role of exchange. The UnPBX is equipped with voice treating board, is a server to operate as a simple PBX, and has a function to store data by using a hard disc.

### SUMMARY OF THE INVENTION

It is therefore an object of the present invention to provide a telephone conference system in which an additional labor and cost are not required, the UnPBX is used not to need an operator, and a plurality of persons can use phones simultaneously.

It is the other object of the present invention to provide a telephone conference system in which a person not to be participated is not permitted to participate in the conference by recognizing ID (identification) of the sender using the UnPBX, the participants are firmly grasped, and a plurality of persons can use phones simultaneously.

To accomplish the object of the present invention there is provided a phone conference system for making a conference using a plurality of phones which comprises: a voice response section for receiving push tone signals and voice signals transmitted from each phone, for transmitting push tone signals and voice signals, and for recording and reproducing voices in response to push tone signals, a voice synthesis section having a plurality of conference rooms in which voice signals from each phone received at said voice response section are synthesized, and a control section for controlling status of said voice synthesis section and for receiving line information from each phone and transmitting orders concerning connection by exchange of lines to said voice response section in response to status thereof, in which said control section designates conference rooms to be connected to each line in regard to a plurality of lines received at voice response section, voice signals of said plurality of lines are synthesized and are connected by exchange in said designated room, and a plurality of persons are capable of making a conversation simultaneously through each phone.

There is also provided a phone conference system for making a conference using a plurality of phones by a computer system which comprises: a voice response section for receiving push tone signals and voice signals transmitted from each phone, for transmitting push tone signals and voice signals, for recording and recognizing IDs of sources of transmission and destination of transmission, and for reproducing voices in response to push tone signals, a voice synthesis section having a plurality of conference rooms, connecting by exchange lines received at said voice response section to phones designated by said IDs, and synthesizing voice signals from the each phones received at said voice response section in conference rooms, a control section for controlling status of said voice synthesis section and for receiving line information from each phone and transmitting orders concerning connection by exchange of lines to said voice response section in response to status thereof, in which said voice response section stores IDs of destinations of transmission of line transmitted from the host phone, simultaneously connecting the phones of plurality of members to the lines thus transmitted, and in case that the call from the connected member within a predetermined time after the line is disconnected, said voice response section recognizes IDs of sources of transmissions and connects the line of said phone of member.

Other objects and aspects of the invention will become apparent from the following description of the embodiments with reference to the accompanying drawings in which:

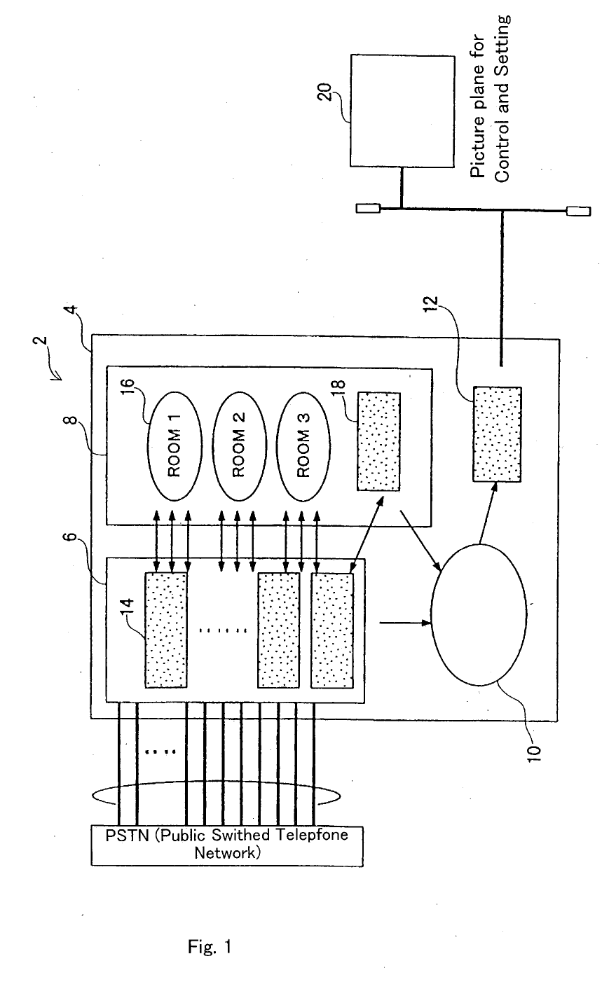

FIG. 1 is a block diagram showing a functional configuration of the telephone conference system common to first and second embodiments according to the present invention,

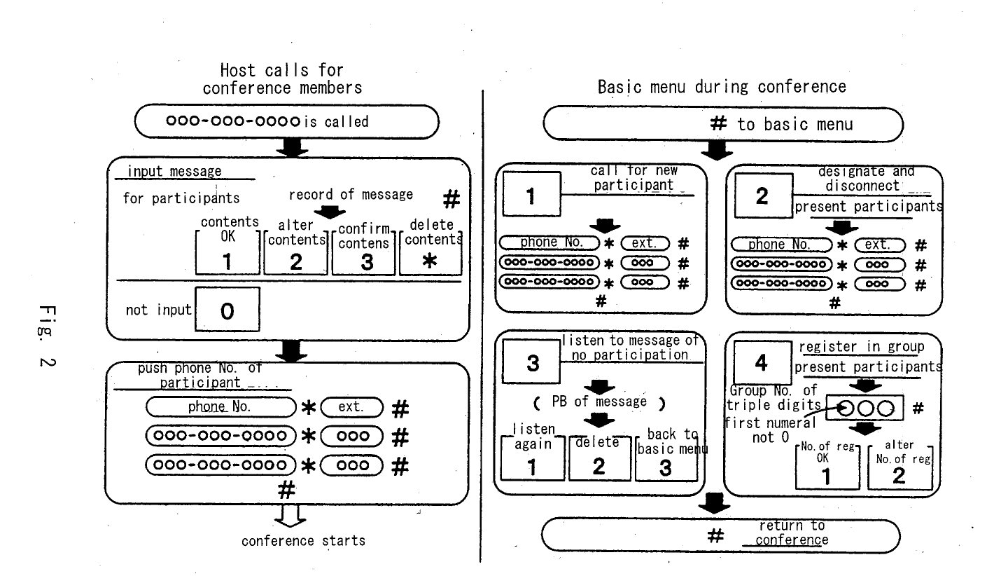

FIG. 2 is a pattern diagram in which featured functions of telephone conference system are picked up,

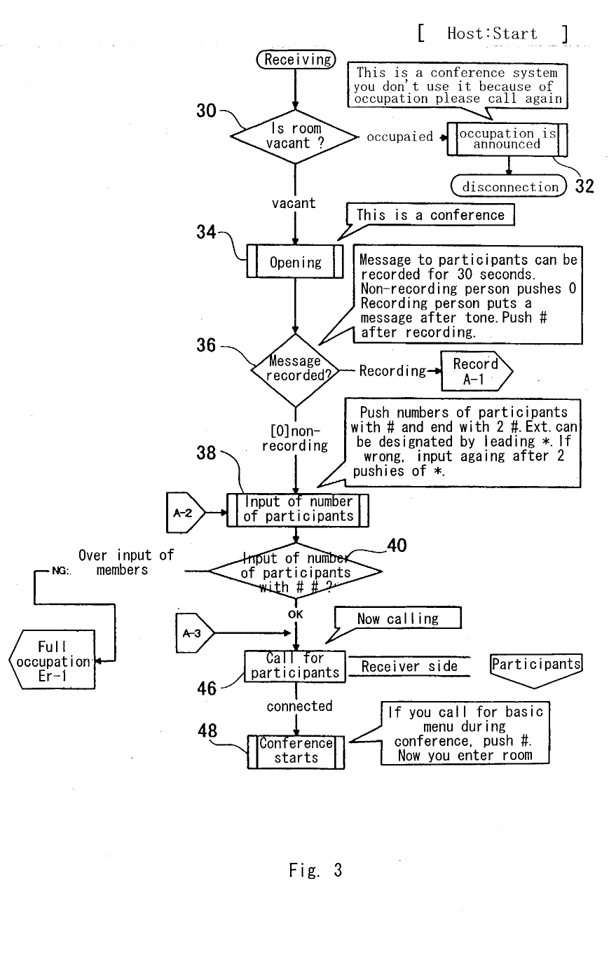

FIG. 3 is a flowchart showing a start menu of an organizer in a treating operation of a server,

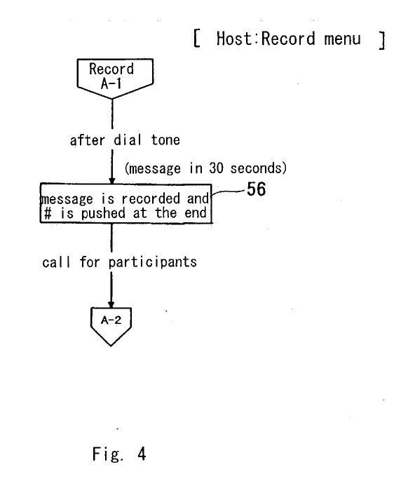

FIG. 4 is a flowchart showing a record menu of an organizer in a treating operation of a server,

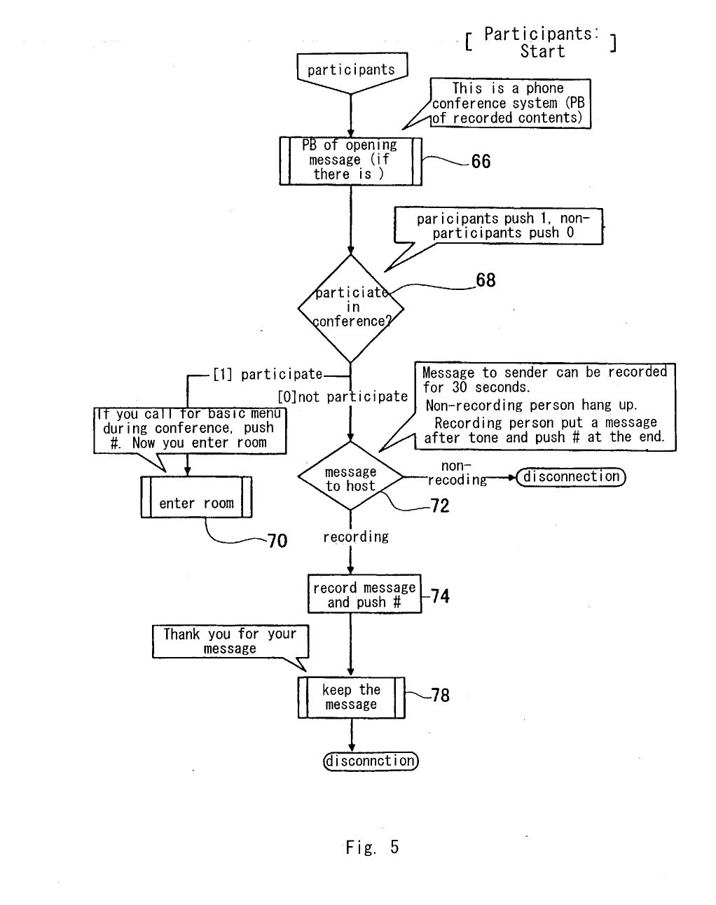

FIG. 5 is a flowchart showing a start menu of a participant in a treating operation of a server,

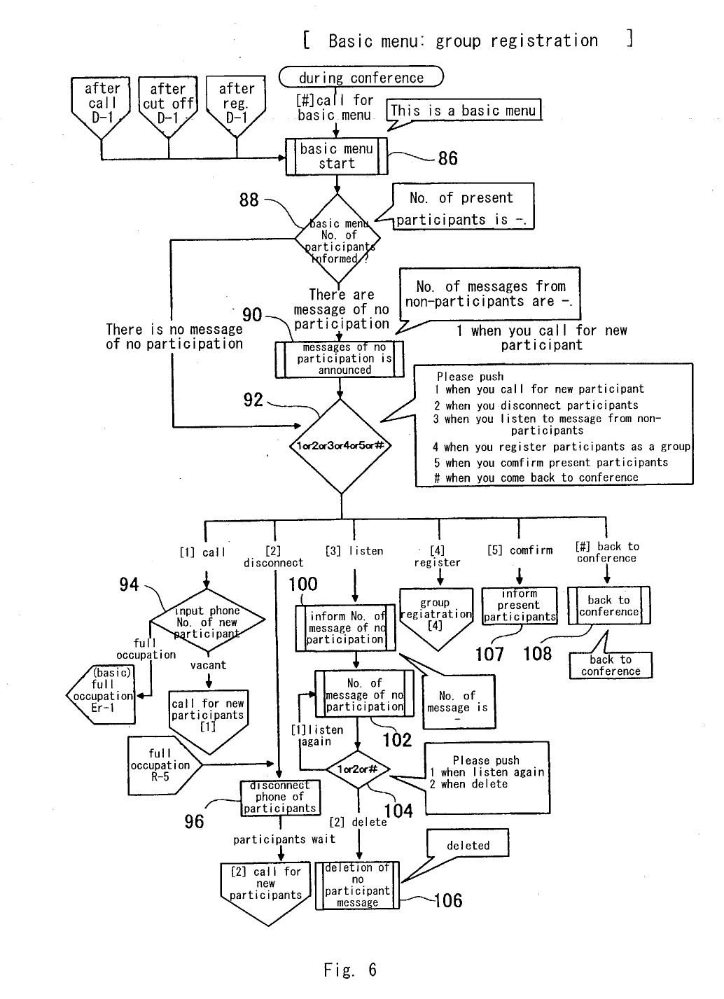

FIG. 6 is a flowchart showing a basic menu in a treating operation of a server,

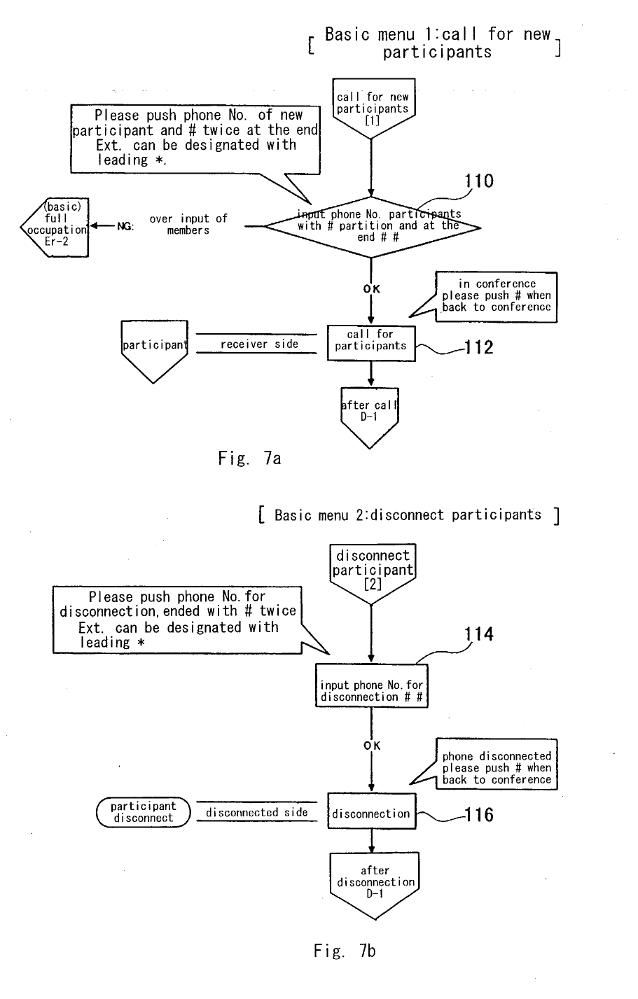

FIG. 7 is a flowchart showing “Mode of call for new participant” on the upper side and “Mode of removal of participant” on the lower side,

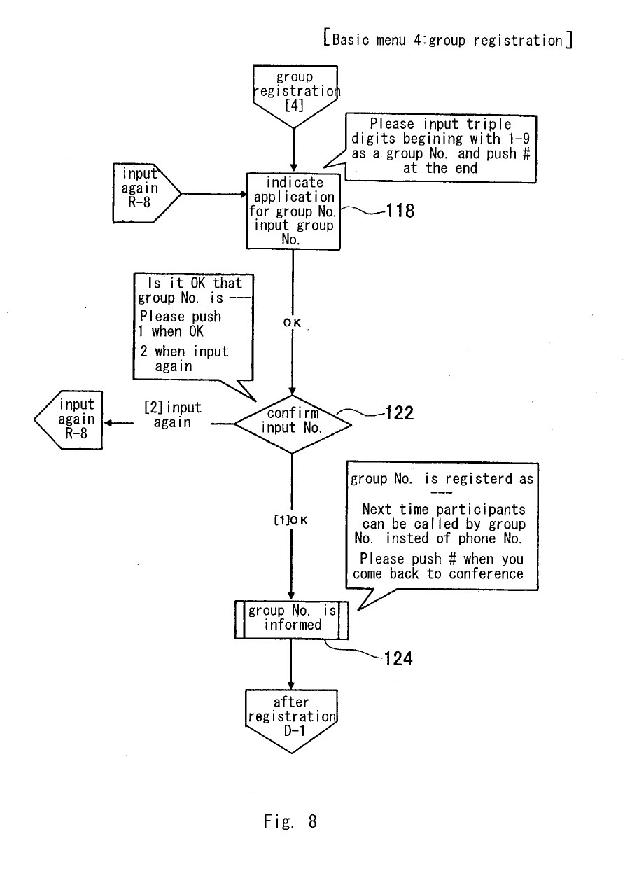

FIG. 8 is a flowchart showing a menu of group registration in a treating operation of a server,

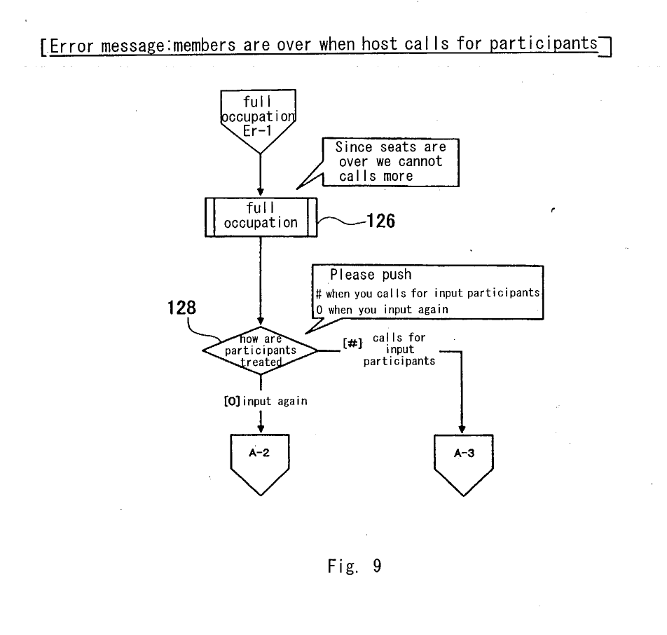

FIG. 9 is a flowchart showing an error message in case where the number of participants goes over when the organizer call for participants,

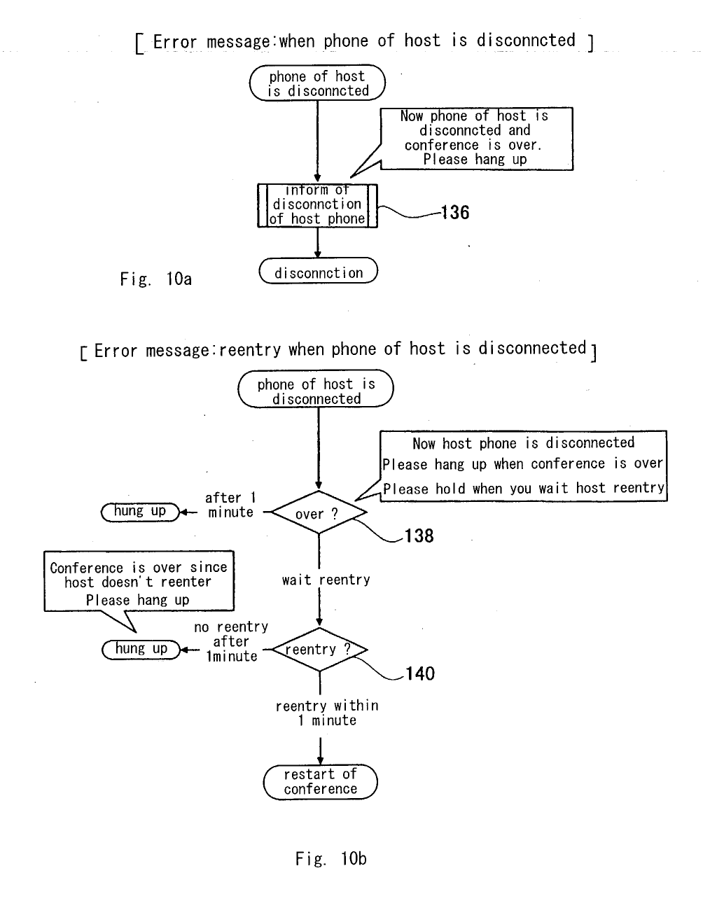

FIG. 10 is a flowchart showing on the upper side an error message in case where the telephone of the organizer is disconnected, shut off or put down and on the lower side an error massage in case of treatment for reentry to room when the telephone of the organizer is shut off,

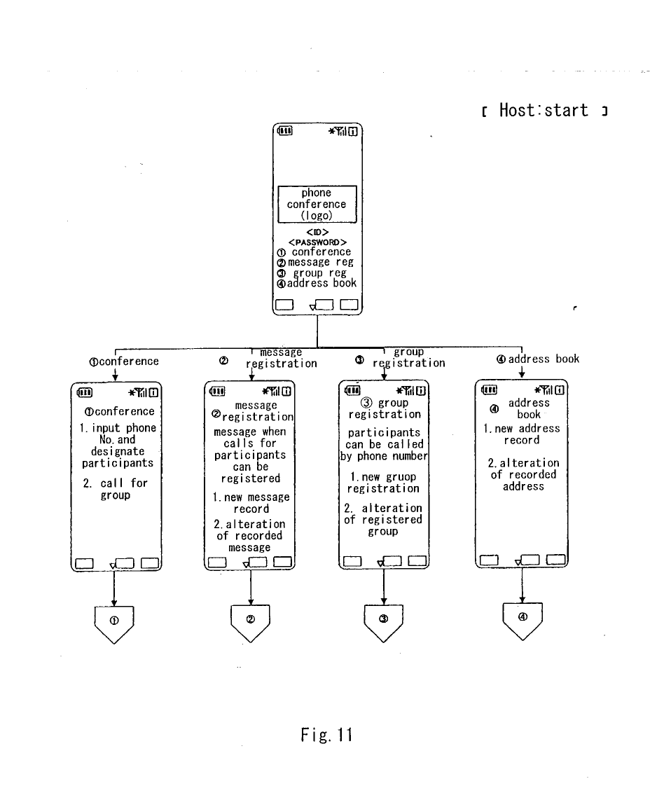

FIG. 11 is a view showing an image plane or picture plane for input of “Organizer: start” menu of portable telephone or cell phone,

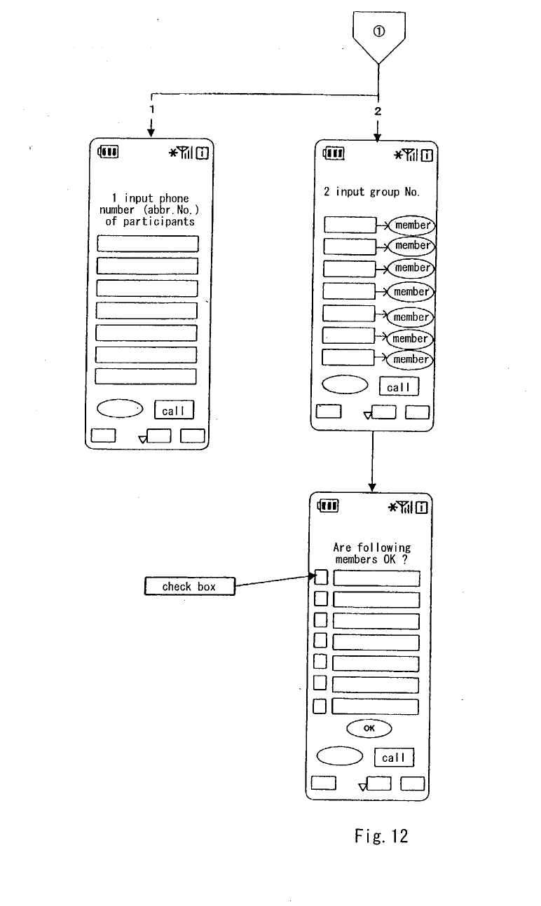

FIG. 12 is a view showing a picture plane for input of portable phone after “1” is selected in FIG. 11,

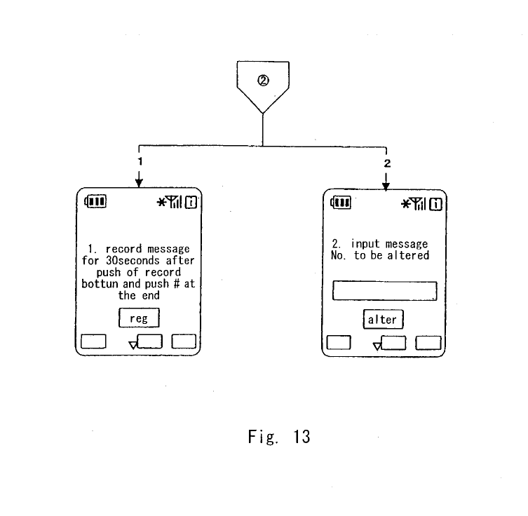

FIG. 13 is a view showing a picture plane for input of portable phone after “2” is selected in FIG. 11,

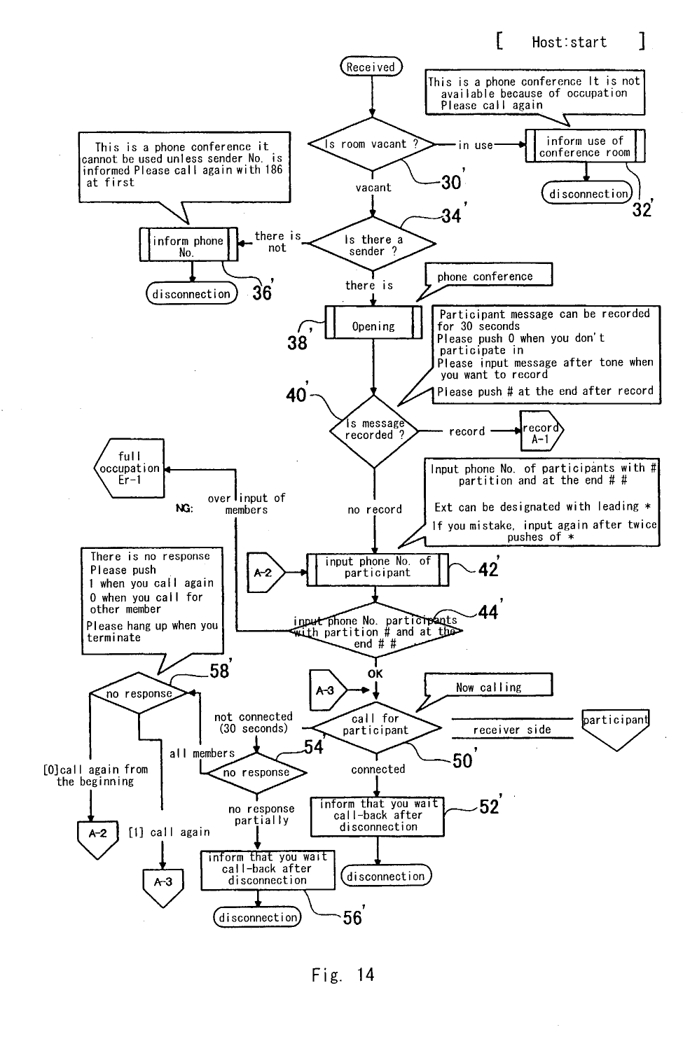

FIG. 14 is a flowchart showing a start menu of an organizer in a treating operation of a server,

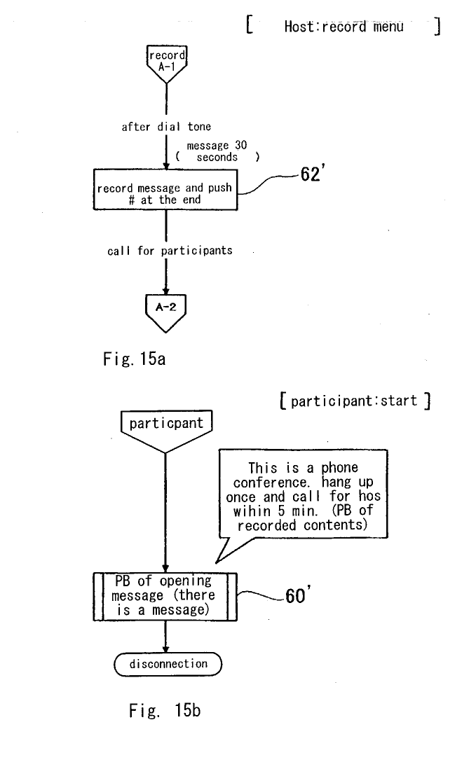

FIG. 15 is a flowchart showing a start menu of a participant,

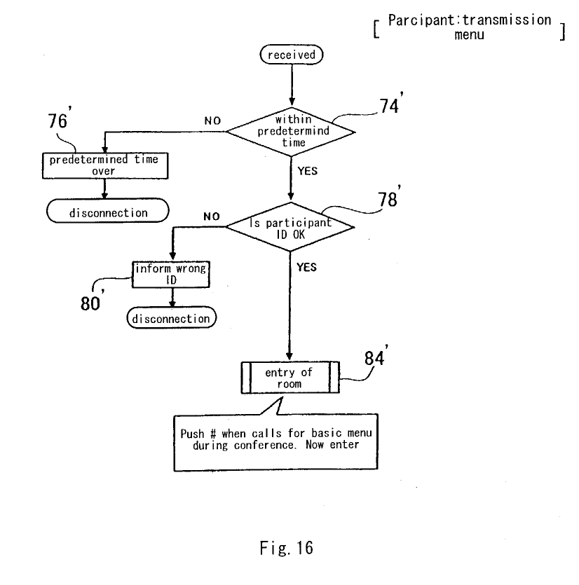

FIG. 16 is a flowchart showing an outgoing mail or transmission menu of a participant in a treating operation of a server,

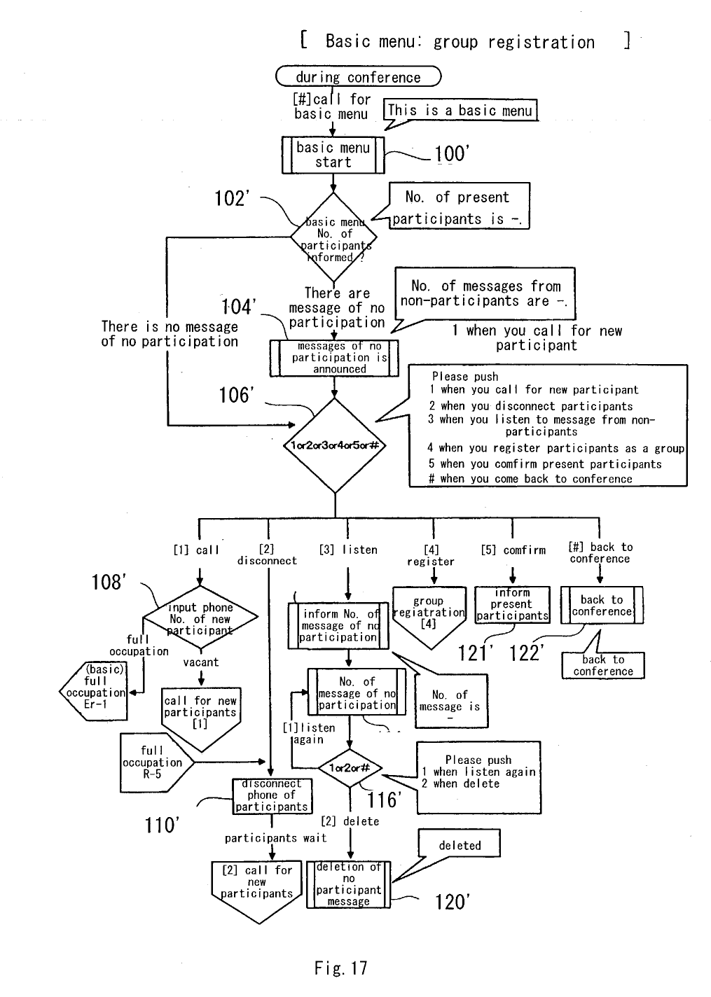

FIG. 17 is a flowchart showing a basic menu in a treating operation of a server, and

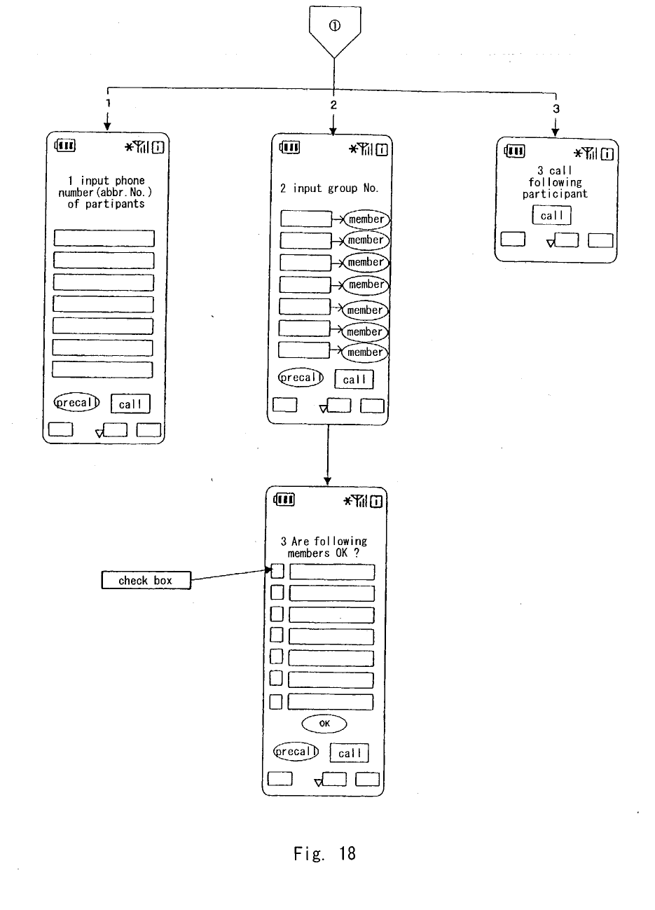

FIG. 18 is a view showing a picture plane for input of portable phone after “1” is selected in FIG. 11.

### DESCRIPTION OF THE PREFERRED EMBODIMENTS

The present invention will be explained with reference to the drawing.

### First Embodiment

In the embodiments, it will be explained on the case where a portable phone, PHS (Personal Handyphone System), a general fixed telephone, hereinafter referred to as phone or telephone is connected to a telephone conference system and a conference is carried out.

FIG. 1 is a block diagram showing a functional configuration of the telephone conference system common to first and second embodiments according to the present invention. In FIG. 1, a server 4 is connected through a public network of NTT (Nippon Telegraph and Telephone Corporation) or TTNet (Tokyo Telecommunication Network Co., Inc.) and ISDN (Integrated Services Digital Network) 23 lines, and also connected to the telephone of users through phone lines.

The server 4 comprises a voice response board 6, a voice synthesis board 8, a record section 10, a display operating section 12. A display section 20 is connected to the server 4 through LAN (local area network).

The voice response board 6 is connected to the telephone of the user through a phone line and has a receiver and transmission function to receive phone communication or push tone signals from the user and to transmit phone communication or push tone signals to the user. Furthermore the voice response board 6 has a voice guide function to record or play back the voice in response to push tone signals or line signals received or transmitted.

The voice response board 6 has a plurality of sections for accommodating a simplified language 14. The simplified language 14 is one for designating a function of various voices/FAX board in a form of simple call for function. The simplified language 14 also has a function of receiving and transmitting push tone and a function of record and play back of voice, and thus makes use of the function of the voice response board 6 easily. Since the simplified languagel4 also has a function to activate an outside program and to receive its executed effects, It is combined with a database or various applications freely to construct a large-scale program and thus enhancing productivity of configuration of voice response system.

The voice synthesis board 8 is connected to the voice response board 6 and has a plurality of rooms 16. Each of the room 16 is a section in which signals transmitted from the voice response board 16 is connected to the designated phone or disconnected from the designated phone by exchange. Each room 16 has a function in which a plurality of member phones are simultaneously connected to each other in response to the line signal transmitted from a host phone by exchange. Furthermore, each room 16 receives push tone signals from host or member phone during exchange and can be connected to a newly designated phone by exchange in response to the push tone signals thus received. When transmitted to the newly designated phone although the voice response board 6 acts for transmission, a line other than the line now used is used for transmission. At a certain time each room 16 differs in the number of exchangeable phones and the number of exchangeable phones is predetermined on each room 16.

The voice synthesis board 8 has a control section 18. The control section 18 controls the status of each room 16 and at the same time has a function to receive signals from the simplified language 14 of the voice response board 16 in response to the status of controlled each room and to transmit indication signals to the simplified language 14. The status of each room 16 is concerned with how many other phones a certain phone is now connected to, how many other phones a certain phone can be further connected to, or the like. Furthermore, when the push tone signals from the host phone reach the server 4 at first, a specific room in which a conference is carried out is acquired by the indication of the control section 18.

A record section 10 is connected to the voice response board 6 and the voice synthesis board 8 and mainly records log information. That is, the record section 10 receives the information from the simplified language 14 and the information from the control section 18 to accumulate information, for example, on what time log in is made, how many members are logged in, how long phone conference is carried out in a room as to how many limited members are in.

A display operating section 12 is connected to the record section 10 and activates a specific language by a specific software to display information on the log of the record section 10. The log information is put out in a form of HTML (Hyper Text Markup Language) format by activating a specific language and running a specific application.

A display section 20 is connected to the server 4 through LAN and receives log information of the display operating section. The display section has a picture plane or screen for control and setting, and the log information in a HTML format is displayed on the picture plane by IE (internet explore). The control and setting are carried out by the user while watching the picture plane. The change in the number of phones or the full number of members by which the exchange for connection can be made at once or concurrently and the setting for the period in which the exchange for connection can be made on the plurality of phones at once are made through the picture plane. Since the log information can be seen on the picture plane of the display section 20 in real time, the present status of the server 4 can be grasped well. Furthermore, the setting for full number of members and the setting for conference period may be made by the users of the phone conference system.

Now, the operation of the above-mentioned construction will be explained. The phone is connected to the server 4 through the public network by transmitting the push tone signals. In the server the simplified language 14 of the voice response board 6 receives the call signal from the push tone signals. Thereafter, the signal for inquiring for status of each room 16 reaches the control section 18, and the control section 18 transmits the signals for indicating the exchange of the line signal to the simplified language 14 in response to the status of each room. The simplifier language 14 transmits a signal to the connected room 16 in accordance with the indicating signals, and then the line signal is connected by exchange in the indicated room. The signal is put out to the simplified language 14 and the push tones are transmitted from the simplified language to the designated phone. The log information during the period is transferred from the simplified language 14 to the record section 10 through the control section 18 and also can be seen on the display section 20 through the display operating section 12 in real time.

On the basis of above-mentioned hardware configuration how treating operations are carried out at the steps of a procedure will be explained in more detail. FIG. 2 is a pattern diagram in which featured functions of telephone conference system are picked up, and FIGS. 3-10 are flowcharts showing in detail treating operations of server 4 of phone conference system according to the embodiment of the present invention. In the flowcharts, a rectangular frame with indication is a message given in voice.

It is assumed that a person calling for a phone conference is a host and a person called in is a participant or member.

In FIG. 3, a start menu of the host is shown a host makes a phone call to the server 4. When the server 4 receives push tones from the host, whether a conference room 16 is vacant or not is checked (step 30). In case that the room is used, the use of conference room is informed with reply message (step 32) and then disconnection is made by the host. In case that the room is vacant, an opening message is announced or delivered (step 34) and whether a message is recorded is inquired (step 36). The message is to the effect that the host delivers to the participants. In case of recording, the procedures go to “Record A-1” mode. In case of non-recording, the message by which persuades the host to put the phone numbers of participants in is delivered (step 38).

When the phone numbers of the participants are put in (step 40), in case of over fixed number of the conference room 16 the procedures go to “Full occupancy Er-1” menu. In case that the phone numbers are not over, connections are established with the participants in the conference room 16 by exchange to call for the participants (step 46). When the phones are connected the conference starts (step 48). The called participants enter “Participant” mode.

In FIG. 4, a host “Record menu” is shown it is a routine from the “Record A-1” in FIG. 3. After dial tone the host records the message (step 56). After the recording the procedures go to “A-2” mode to call for the participants. The “A-2” mode is linked to “step 38” in FIG. 3.

In FIG. 5, a participant “Start menu” is shown. When the participant gets phone call in accordance with the call from the host, opening message is announced and in case that there is a massage from the host the massage is played back or reproduced (step 66). Whether the participant attends the conference is inquired (step 68) and in case of attendance the participant enters the conference room (step 70). In case that the participant does not attend, whether the massage to the host is recorded is inquired (step 72). In case of non-recording the participant disconnects or hangs up the phone. In case of recording the participant records the message (step 74). After the recording the message is stored (step 78). Then the participant hangs up.

In FIG. 6, a basic menu is shown. When the basic menu is called during the conference, the basic start menu message is announced (step 86). The number of conference participants is informed (step 88) and in case that there are non-attendance messages the number of non-attendance messages is informed (step 90). The choice concerning whether a new participant is called, whether the phones of present participants are hung up, whether the participant listens to the non-attendant message, whether the group registration is made, whether the present participants are confirmed, and whether the participant returns to the conference is inquired (step 92). In case that there is a non-attendance massage at the step 88 the procedures go to the step 92.

In case that a new participant is called for, the number of the new participant is put in (step 94). In case of full occupancy, the procedures go to “Full occupancy Er-2” menu and in case that there are vacancies for seats the procedures go to “Call for new participant” mode. On the “Full occupancy Er-2” menu the message about full occupancy is announced and whether the participant hangs up or whether the participant returns to the conference is inquired. In case that the phone of present participant is hung up, the procedures go to “Full occupancy R-5” menu in FIG. 6 and in case that the participant returns to the conference the message to that effect is announced.

In case that the phone of present participant is hung up the procedures go to “hang up” step (step 96) and in case that there is a participant the procedures go to “Hanging up the phone of the present participant: 2” mode.

In case that the participant listens to the message from the non-participant or non-attendant, the number of the non-participant is informed (step 100) and then the message from the non-participant is reproduced (step 102). In case that the participant listens to the message again after reproduction, the procedures go back to step 102 (step 104) and in case that reproduced message is deleted (104), the message is deleted (step 106).

In case of group registration, the procedures go to “Group registration: 4” mode in FIG. 8.

In case of confirmation on present participants, the present participants are announced (step 107).

In case of the return to the conference, the message to that effect is announced and the participant returns to the conference (step 108).

In FIG. 7a, “Call for new participant: 1” mode is shown. The number of the new participant is put in (step 110). On the input the extension number of the new participant can be designated. In case that the capacity for the conference room goes over the full number, the procedures go to “Full occupation Er-2” menu. On the “Full occupation Er-2” the message of full occupation is announced, and whose phone is hung up or whether the participant returns to the conference is inquired. In case that the phone of the present participant is hung up, the procedures go to “Full occupation R-5” menu in FIG. 6, and in case that the participant returns to the conference, the message to that effect is announced and the participant returns to the conference. When the input of phone number is proper in step 110, a new participant is called for (step 112) and is linked to “After call D-1” menu and the procedures go to step 86. A receiver goes to “Participant” mode in FIG. 5.

In FIG. 7b, “Hanging up the phone of the participant: 2” mode is shown. The phone number desired to be hung up is put in. On inputting the extension number can be designated. The phone which is desired to be hung up is hung up (step 116), and is linked to “After hanging up D-1” menu in FIG. 6 which is linked to the step 86.

In FIG. 8, “Group registration” menu is shown. When group registration of present participants at the step 92 in FIG. 6 is selected, the numbering of group is indicated and at the same time the number of group is put in (step 118) and thereafter the number thus input is confirmed (step 122). When the participant does it again, the procedures go back to the step 118. When the input number is correct, the group number is announced (step 124). Thereafter, the procedures go to “After registration D-1” in FIG. 6 which in turn goes to the step 86. When the group is registered, if the group number is put in at the next time, the participants which belong to the group can be called for.

In FIG. 9, an error message “When the participants go over full number” menu is shown. It is a routine from the “Full occupancy Er-1” in FIG. 3. The message to the effect that the seats have been already full occupied is announced (step 126) and how the input participant is handled is inquired (step 128). When input again, the procedures go to “A-2” mode in FIG. 3. In case that the participants are called for, the procedures go to “A-3” mode in FIG. 3.

On the upper side of FIG. 10, an error message “when the phone of the host” menu is shown. When the phone of the host is hung up, the message to that effect is announced (step 136) and the phones of all participants are caused to hang up.

On the lower side of FIG. 10, an error message of “Reentry of conference room when the phone of the host” menu is hung up is shown. The menu is alternatively used in place of the step 136. When the phone of the host is hung up, whether the conference is terminated is inquired (step 138) and if the conference is terminated, the phones of all participants are caused to hang up in one minute. In case that the reentry of the host is waited (step 140), when the host enter the conference room again within one minute the conference is restarted. Furthermore, before the reentry of the host the conference can be carried out between the participants. When the host does not enter the room again within one minute, the phones of all participants are caused to hang up.

Further, in conference the volume of phone call is adjustable. Furthermore, a particular person of the participants can be given a voice by the host. Moreover, since a plurality of conference rooms can be set a plurality of groups can have phone conferences at the same time.

The present invention can be embodied using the above-mentioned flowchart and therefore the conferences can be held at the same time between the remote places where there are no television phones.

According to the embodiment, connection can be made without an operator, new participant can be called for during the conference, and the conference system can be utilized 24 hours. Further, when the user utilizes the phone conference system the initial registration is not required although the password on the start stage of the conference system is required.

Now, an altered embodiment will be explained. In the above-mentioned embodiment, the example in which the buttons of the phone are operated in accordance with voice message generated from the voice response board 6, and then the conference call and the call for the member are carried out has been explained. The operation of conference call and the like are carried out by cell phones through internet lines will be explained. In FIGS. 11-13, there is shown an input picture plane of cell phone in case that orders and information are transmitted to the voice response board 6 from the cell phone with phone functions and capable of transmitting orders or information through the internet lines to make various setting.

FIG. 11 shows an input picture plane for “Host: start” menu is shown. At first ID (identification) and password are put in on use of internet lines. Settable items include 1 Conference, 2 Registration of message, 3 Registration of group, and 4 Address book.

In case of the conference, the conference is selected on the picture plane. Thereafter, one of “1 Designation of participants by inputting phone numbers” and “2 Call” is selected. FIG. 12 shows picture planes after selection. In case of selection of 1, the phone numbers (or abbreviated numbers) of the participants are put in. When participants are called for after input, “Call button” is pushed. In case of selection of 2, the group number is put in. When the group number is put in the view of the members in the group appears. When the appeared members are fine, “OK” button is pushed and “Call” button is pushed to call. When persons are desired to count out from the members, checks in check boxes are removed and “OK” button and “Call” button are pushed.

In case of registration of message, “2 Registration of message” is selected. Thereafter, one of “1 Record of new message” and “2 Alternation of recorded message” is selected. In FIG. 13, the picture plane after selection is shown. In case of selection of 1, record button is pushed to record a message and # is pushed. In case of selection of 2, the number of message is put in and a new message in place thereof is recorded.

In case of “Registration of group” or “Address book”, desired one of options is selected on the picture plane in sequence in a similar manner to those of “1 Conference” or “2 Registration of message”.

The voice response board 6 can receive orders and information input on the cell phone and the control section 18 receives line information from the voice response board 6 in response to orders and information thus received and transmits exchange connection to the voice response board 6.

As mentioned above, since the input information can be transmitted while confirming the input information on the picture plane by transmitting orders and information through the picture plane of the cell phone capable of utilizing internet lines, errors in operations are not likely to be caused and therefore unfailing and ease operations and transmission of information are available.

### Second Embodiment

In the second embodiment, the functional configuration of the telephone conference system shown in FIG. 1 is also used. The explanation on sections and functions of the second embodiment which are same or similar to those of the first embodiments will be omitted.

In the second embodiment, the simplified language 14 has functions to store the phone numbers of the destination of transmitting lines and to store the ID (identification number) or the phone numbers of senders from the line signals, and also has a function to check the stored transmitted phone number to the received phone number. The simplified language can simultaneously connect a plurality of phone lines for destination of transmitters to one transmitting line. However, since the simplified language 14 is connected to the sending line and also connected to the plurality of phone lines, the simplified language itself does not directly connect the sending line to the plurality of lines of transmitters and is not a section where voice signals are exchanged between the sending line and transmitting phone lines. The exchanges are carried out in the rooms 16 of voice response board 8.

Now, the operation of the above-mentioned construction will be explained. The phone is connected to the server 4 through the public network by transmitting the push tone signals. In the server the simplified language 14 of the voice response board 6 receives the call signal from the push tone signals. Thereafter, the signal for inquiring for status of each room 16 reaches the control section 18, and the control section 18 transmits the signals for indicating the exchange of the line signal to the simplified language 14 in response to the status of each room. On the stage the room is reserved for conference.

The simplifier language 14 calls for the phones of the members who the host designates. The simplified language 14 stores the phone number of the sender or the host and the phone of the members who the host designates. When the members receive the call from the host a predetermined message is announced and the members and the host hang up.

After the phone of the host or the member is once hung up, the members call for the host after a predetermined time for example in 5 minutes. The members call through public network of the NTT or TTNet line to connect the phones of the members to the server 4. In the server 14, the simplified language 14 of the voice response board 6 receives the call signals. The simplified language 14 recognizes the phone numbers of the members and checks whether the phone numbers coincide with the phone numbers of the members which the host designates. If the he phone numbers coincide with the phone numbers of the members, the simplified language 14 connects the lines from the members. If not, the line is not connected.

In case of coincidence line information is delivered from the simplified language 14 to the control section 18 and the control 18 issues the order for indicating the connection of lines by exchange in the room designated when the host calls for the members to the simplified language 14. The simplified language 14 issues signals to the room 16 thus connected in accordance with the order, that is, the lines of the members are connected to the line of the host. Since the room is a conference room, the room synthesizes the voice signals of plurality of lines to be connected by exchange. The synthesized voice signals are issued to the simplified language 14 which in turn issues to each phone.

On the basis of above-mentioned hardware configuration how treating operations are carried out at the steps of a procedure will be explained in more detail. FIGS. 14-16 are flowcharts showing the detailed treating operations of server 4 of phone conference system according to the second embodiment of the present invention. In the flowcharts, a rectangular frame with indication is a message given in voice.

In FIG. 14, a start menu of the host is shown a host makes a phone call to the server 4. When the server 4 receives push tones from the host, whether a conference room 16 is vacant or not is checked (step 30′). In case that the room is used, the use of conference room is informed with reply message (step 32′) and then disconnection is made by the host. In case that the room is vacant, whether there is a sender information is checked (step 34′). In case of no sender information, the message to the effect that the phone is redialed by the information by sender (step 36′) and the line is disconnected. In case that there is sender information on opening message is delivered (step 38′) and whether a message is recorded is inquired (step 40′). The message is to the effect that the host delivers to the participants. In case of recording, the procedures go to “Record A-1” mode. In case of non-recording, the message by which persuades the host to put the phone number participants in is delivered (step 42′).

When the phone numbers of the participants are put in (step 44′), in case of over fixed number of the conference room 16 the procedures go to “Full occupancy Er-1” menu (detailed explanation will be omitted). In case of proper input, the participants are called for (step 50′).

When the phone is connected, it is informed that the phone is hung up once and the host waits for the phone from the participants (step 52′), and the host hangs up. The participants who is called goes to “Participant” mode.

In case of disconnection of the phone, whether the disconnection of the phones is caused as to all members or some of them is judged (step 54′). In case of no response from the all members (step 58′) and redialing from the beginning the procedures goes to “A-2” mode. In case of calling for the last member the procedure goes to “A-3” mode. In case of no response from some of them on the step 54′, the message to the effect that the host hung up once and wait for the calls from the participants is announced (step 56′) and then the host hangs up.

In FIG. 15a host “Record menu” is shown. The steps are same as those of FIG. 4 and therefore the explanation thereof will be omitted.

In FIG. 15b a participant “Start menu” is shown. When the participant gets phone call in accordance with the call from the host, opening message is announced to inform that the participants hang up once and redial within 5 minutes. In case that there is a massage from the host the massage is played back or reproduced (step 60′).

In FIG. 16 a participant sending menu is shown. The participants call for the server 4. When the server 4 receives call signals participants call for the server 4. When the server 4 receives call signals from the participants the server judges whether the call from the participant within a predetermined time (5 minutes in the embodiment) from the calling of the host (step 74′). In case of overtime, the message to that effect is announced and the phone is caused to hang up (step 76′). In case of in time whether the sender number of the participant is the same as that of the phone which the host calls for is judged (step 78′). If different, the message to that effect is delivered (step 80′) and the phone is caused to hang up. If the same, the participant is permitted to enter the conference room (step 84′).

In FIG. 17, a basic menu is shown. When the basic menu is called during the conference, the basic start menu message is announced (step 100′). The number of conference participants is informed (step 102′) and in case that there are non-attendance messages the number of non-attendance messages is informed (step 104′). The choice concerning whether a new participant is called, whether the phones of present participants are hung up, whether the participant listens to the non-attendant message, whether the group registration is made, whether the present participants are confirmed, and whether the participant returns to the conference is inquired (step 106′). In case that there is a non-attendance massage at the step 88 the procedures go to the step 106′.

In case that a new participant is called for, the number of the new participant is put in (step 108′). In case of full occupancy, the procedures go to “Full occupancy Er-2” menu and in case that there are vacancies for seats the procedures go to “Call for new participant” mode.

In case that the phone of present participant is hung up the procedures go to “Hang up” step (step 110′) and in case that there is a participant the procedures go to “Hanging up the phone of the present participant: 2” mode.

In case that the participant listens to the message from the non-participant or non-attendant, the number of the non-participant is informed (step 114′) and then the message from the non-participant is reproduced (step 116′). In case that the participant listens to the message again after reproduction, the procedures go back to step 116′ (step 118′) and in case that reproduced message is deleted (118′), the message is deleted (step 120′).

In case of group registration, the procedures go to “Group registration: 4” mode.

In case of confirmation on present participants, the present participants are announced (step 121′).

In case of the return to the conference, the message to that effect is announced and the participant returns to the conference (step 122′).

Now, an altered embodiment will be explained. In the above-mentioned embodiment, the example in which the buttons of the phone are operated in accordance with voice message generated from the voice response board 6, and then the conference call and the call for the member are carried out has been explained. The operation of conference call and the like are carried out by cell phones through internet lines will be explained. In FIG. 18, there is shown an input picture plane of cell phone in case that orders and information are transmitted to the voice response board 6 from the cell phone with phone functions and capable of transmitting orders or information through the internet lines to make various setting.

The procedures explained with reference to FIGS. 6 and 8 in the first embodiment are applicable to the procedures in the second embodiment.

In FIG. 18, the procedures when “1 Designation of participants by inputting phone numbers” and “2 Call” is selected have been already explained with reference to FIG. 12. In FIG. 18, In case of selection of “3 Call for the participant who was previously called”, the name of participant is displayed. When the participant is called, the call button is pushed.

What we claim:

1. A phone conference system for making a conference using a plurality of phones which comprises:
a voice response section for receiving push tone signals and voice signals transmitted from each phone, for transmitting push tone signals and voice signals, and for recording and reproducing voices in response to push tone signals,
a voice synthesis section having a plurality of conference rooms in which voice signals from each phone received at said voice response section are synthesized, and
a control section for controlling status of said voice synthesis section and for receiving line information from each phone and transmitting orders concerning connection by exchange of lines to said voice response section in response to status thereof,
in which said control section designates conference rooms to be connected to each line in regard to a plurality of lines received at voice response section, voice signals of said plurality of lines are synthesized and are connected by exchange in said designated room, and a plurality of persons are capable of making a conversation simultaneously through each phone.

2. A phone conference system according to claim 1 in which during connection of plurality of lines, said voice response section receives push tone signals from at least one of said plurality of phones and transmits push tone signals to newly designated, after said voice response section receives push tone signals from said newly designated phone the voice signals from the line of newly designated phone in accordance with the order of said control section are synthesized with the voice signals from the other phones at the designated conference room and connected by exchange, and the newly designated phone is capable of participating in the conference which the plurality of other phones have participated in.

3. A phone conference system according to claim 1 in which during connection of plurality of lines, said voice response section receives push tone signals from at least one of said plurality of phones, and said control section receives line information from said voice response section in regard to the phone designated by said push tone signals and sends an order to said voice response section to disconnect of line to said designated phone which leads to disconnection of line of said designated phone.

4. A phone conference system according to claim 1 in which during connection of plurality of lines, when the line of the host phone is disconnected said control section sends an order to the connected phones of all members to disconnect the phones of all members which leads to disconnection of line of said designated phone.

5. A phone conference system according to claim 1 in which said voice response section is capable of recording the voice to be sent to more than one designated phones of members after the voice response section receives push tone signals from the host phone, and voice response section reproduces said recorded voice when the phones of more than one members are designated and then lines to the phones of members are connected.

6. A phone conference system according to claim 1 in which after the voice response section receives push tone signals from the host phone, and when the phones of more than one members are designated section said voice response is capable of recording the voice from the members phones to the host phone after the push tone signals from the member phones are received, and thereafter during connection by exchange of the host phone said voice response section is capable of reproducing the recorded voice.

7. A phone conference system according to claim 1 in which while said voice response section receives push tone signals from the host member and synthesizes voice signals from the each phone at the conference room to connect the host and the members, the phones of the members connected at the present time can be registered as a group.

8. A phone conference system according to claim 1 in which the number of the phones in which plurality of voice signals are synthesized and simultaneously connected by exchange is settable in the each conference room.

9. A phone conference system according to claim 1 in which the time in which a plurality of voice signals are synthesized and simultaneously connected by exchange is settable to a predetermined time.

10. A phone conference system according to claim 1 in which a record section is provided for recording information on which a plurality of voice signals are synthesized and simultaneously connected by exchange.

11. A phone conference system according to claim 10 in which the information recorded in the record section is visual in real time.

12. A phone conference system according to claim 1 in which during connection of plurality of lines, in case that the line of the host is disconnected the line of host is connected by exchange within a predetermined time after disconnection to reenter the conference room and in case that the line of host is not connected by exchange within a predetermined time the phones of all members is disconnected.

13. A phone conference system according to claim 1 in which said voice response has a phone function and can receive orders and information inputted from a picture plane through internet lines from the cell phone capable of transmitting orders and information from the picture plane through the internet, and said control section is capable of receiving line information and send an order in regard to connection by exchange to said voice response section in response to the received orders.

14. A phone conference system according to claim 1 in which said orders and information which said voice response section can receive includes information for calling up members and calling for members.

15. A phone conference system for making a conference using a plurality of phones by a computer system which comprises:
a voice response section for receiving push tone signals and voice signals transmitted from each phone, for transmitting push tone signals and voice signals, for recording and recognizing IDs of sources of transmission and destination of transmission, and for reproducing voices in response to push tone signals,
a voice synthesis section having a plurality of conference rooms, connecting by exchange lines received at said voice response section to phones designated by said IDs, and synthesizing voice signals from the each phones received at said voice response section in a conference room
a control section for controlling status of said voice synthesis section and for receiving line information from each phone and transmitting orders concerning connection by exchange of lines to said voice response section in response to status thereof,
in which said voice response section stores IDs of destinations of transmission of line transmitted from the host phone, simultaneously connecting the phones of plurality of members to the lines thus transmitted, and in case that the call from the connected member within a predetermined time after the line is disconnected, said voice response section recognizes IDs of sources of transmissions and connects the line of said phone of member.

16. A phone conference system according to claim 16 in which said voice response section is capable of recording the voice to be sent to more than one designated phones of members after the voice response section receives push tone signals from the host phone, and voice response section reproduces said recorded voice when the phones of more than one members are designated and then lines to the phones of members are connected.

17. A phone conference system according to claim 16 in which there is provided a record section for storing information on connection by exchange.

18. A phone conference system according to claim 17 in which the information recorded in the record section is visual in real time.

19. A phone conference system according to claim 15 in which said voice response has a phone function and can receive orders and information inputted from a picture plane through internet lines from the cell phone capable of transmitting orders and information from the picture plane through the internet, and said control section is capable of receiving line information and send an order in regard to connection by exchange to said voice response section in response to the received orders.

20. A phone conference system according to claim 19 in which said orders and information which said voice response section can receive includes information for calling up members and calling for members.
